(19) United States
(12) Patent Application Publication
(10) Pub. No.: US 2009/0294337 A1
(43) Pub. Date: Dec. 3, 2009

(54) Device for Separating Flat Mail Items

(75) Inventor: Jürgen Francke, Berlin (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, München (DE)

(21) Appl. No.: 12/441,773

(22) PCT Filed: Sep. 21, 2007
(86) PCT No.: PCT/EP2007/060027

§ 371 Date: Apr. 21, 2009

(30) Foreign Application Priority Data
Sep. 22, 2006 (DE) 10 2006 044 784.0

(51) Int. Cl. B07C 3/10; B07C 5/36

(52) U.S. Cl. 209/552; 209/643; 209/606

(57) ABSTRACT

An apparatus for separating flat mail items includes two transport devices for transporting two independently mobile stacks of mail items to an extraction device for extracting mail items from both stacks of mail items and supplying the mail items to a transport run. A single-component extraction element of the extraction device is provided for extracting mail items from the two stacks of mail items. An economical device for separating flat mail items from both stacks of mail items can be obtained, and the device generates a continuous flow of mail items.

The invention relates to a device for separating flat mail items, said device comprising two transport means for transporting two independently mobile stacks of mail items to an extraction means, for extracting mail items from both stacks of mail items and feeding the mail items into a transport run, whereby the extraction means has a single-component extraction element for extracting mail items from both stacks of mail items.

In everyday postal services, an extremely wide variety of mail items are transported in different receptacles, for example in stacks in containers or unsorted in sacks. In order to allow the mail items to be processed individually by machine, to sort them for example, the mail items need to be separated. To this end, the mail items are generally deployed onto a flatbed conveyor which transports the mail items in a separating stack formed in this way to a separating facility which separates the mail items. During the separation process, the leading mail item in the separating stack is always extracted by an extraction element, an extraction belt for example, and fed to a transport run, with the result that a continuous flow of mail items is generated there.

The deployment of differing types of mail items from different receptacles onto the flatbed conveyor requires a great deal of manual labor and proceeds efficiently in the case of well pre-stacked mail items which are similar to one another and more slowly in the case of greatly differing and, in particular, inherently unstable mail items. Furthermore, a separating stack is reduced with differing speed by the separating facility depending on the thickness of the separated mail items. It can thus happen that a separating stack is reduced more quickly than new mail items are deployed onto the flatbed conveyor, the separating facility runs empty and the continuous flow of mail items is interrupted.

A separating device is known from EP 1 415 732 A1, which has two extraction means. A stack of mail items containing normal, flat mail items is fed to the first extraction means and the extraction means is operated discontinuously as a slave, a universal feeder in the technical terminology. A stack of mail items containing mail items which are more difficult to stack is fed to the second extraction means and this is operated continuously as a master, or ECR, feeder. As soon as the master runs empty, the slave with the constantly filled flatbed conveyor engages and fills the gap in the flow of mail items.

A separating device with a circulating belt for extracting mail items from two stacks of mail items situated opposite one another is known from U.S. Pat. No. 4,688,782. A separation process from two stacks of mail items with the aid of a swivel-mounted gripping arm which lifts the mail items by means of suction cups from the stacks of mail items is known from U.S. Pat. No. 2,352,088.

The object of the present invention is to set down a cost-effective device for separating flat mail items, with which a continuous flow of mail items can be generated.

This object is achieved by a device, of the type stated in the introduction, for separating flat mail items, which according to the invention comprises a retaining means for selectively feeding mail items from either the first or the second stack of mail items to the extraction element, whereby the retaining means has a first and a second retaining element for holding back mail items from the first or second stack of mail items respectively, which can be moved synchronously by means of a drive in such a manner that a retaining movement of the first retaining element is coupled with a release movement of the second retaining element. Both stacks of mail items can be directed to a single extraction element, which means that a second extraction means can be dispensed with. Savings can be achieved in respect of construction volume and duplicated elements; it is for example possible to dispense with a separate drive for the second extraction means, and cost savings can be achieved.

The extraction element can be a circulating belt which consists of one band or a plurality of synchronously moved bands, in particular arranged one above or one after the other. The transport means are preferably flatbed conveyors. The mail items can be postal items. The invention is however not restricted to the latter, which means that the mail items can equally well be any other objects which are to be transported to a destination, for example through the transport run. Print products, in particular documents, forms, labels and the like are conceivable, amongst other things.

The two stacks of mail items can be directed to the extraction element from the same direction, above one another for example. The extraction means can be implemented in a particularly small construction volume and a particularly simple manner if the two stacks of mail items are however directed to the extraction element from different directions. In the case of the stacks of mail items being directed to the extraction element from opposite directions, a combination of the two flows of mail items formed from the two stacks of mail items is particularly simple.

In an advantageous embodiment of the invention, a direction of motion of the extraction element is reversible. By this means, mail items from stacks of mail items directed to the extraction element from different directions can be separated such that they can be directed in the same direction towards the transport run. Mail items from the first stack of mail items can be separated in a first direction of motion and mail items from the second stack of mail items can be separated in a second direction of motion. To this end, the extraction element advantageously has a first extraction area with a first direction of motion and a second extraction area with an opposite second direction of motion, and the first stack of mail items is directed to the first extraction area and the second stack of mail items is directed to the second extraction area.

In order to be able to direct mail items selectively from the first or second stack of mail items to the extraction belt, mail items from whichever is the other stack of mail items must be held back by the extraction element. To this end, the device comprises the retaining means for selectively feeding mail items from either the first or the second stack of mail items to the extraction element. A feed of mail items from the stack of mail items from the master for example can be interrupted if the latter's stack of mail items has become small, such that the latter does not need to be separated in its entirety until mail items are separated by the slave.

The retaining means can be implemented in a particularly fault-resilient and cost-effective manner because it has a first retaining element and a second retaining element for holding back mail items from the first or second stack of mail items respectively, whereby the two retaining elements can be moved synchronously by means of one drive. It is possible to dispense with a plurality of control elements and drives and the device can be kept compact.

Furthermore, a retaining movement of the first retaining element is linked with a release movement of the second retaining element. In this manner, it is possible with a single drive to simultaneously terminate a feed of mail items from one stack of mail items to the extraction element and commence a feed of mail items from the other stack of mail items.

The mail items on the transport means are moved by means of advancing the transport means in the direction of the extraction element. This advance is advantageously controlled in a not uninterrupted fashion, but it is activated in the situation when a pressure of the mail items in the stack of mail items in the direction of the extraction element drops below a predefined value. To this end, a sensor is required whose measurement values are used for controlling the advance and which is advantageously arranged between the stack of mail items and the extraction element. It is possible to dispense with an additional sensor holder if the retaining elements carry sensors used for controlling a movement of the stack of mail items.

For the purpose of extracting from the stack of mail items the mail items to be separated the extraction element, advantageously the extraction belt, has an exterior material with a high static and dynamic friction. In order to hold the mail items securely on this material without needing to press them onto the extraction belt with a high pressure, a suction means can be present which sucks the mail items to the extraction belt and holds them thus on the extraction belt. In an advantageous development of the invention, a suction means for sucking the mail items from both stacks of mail items is arranged inside an area circumscribed by the extraction element. Mail items from both stacks of mail items can be held on the extraction belt by the one suction means and savings can be achieved in respect of components and costs.

By preference, the direction of suction of the suction means can be switched over. By this means it is possible to achieve a situation where the entire suction capacity of the suction means is concentrated on mail items in the stack of mail items currently to be separated and no suction capacity is wasted on the inactive stack of mail items.

In order to achieve a flow of mail items with a high mail item throughput, it is possible to predefine a spacing which is to be observed between mail items in the flow of mail items, which means that smaller mail items can be separated at a higher rate than larger mail items. A continuous flow of mail items in the event of a switch in separation from one stack of mail items to the other can be achieved if the device comprises a control unit for controlling the movement of the extraction element in such a manner that the same spacing is set between two successive mail items from different stacks of mail items as between two successive mail items from the same stack of mail items.

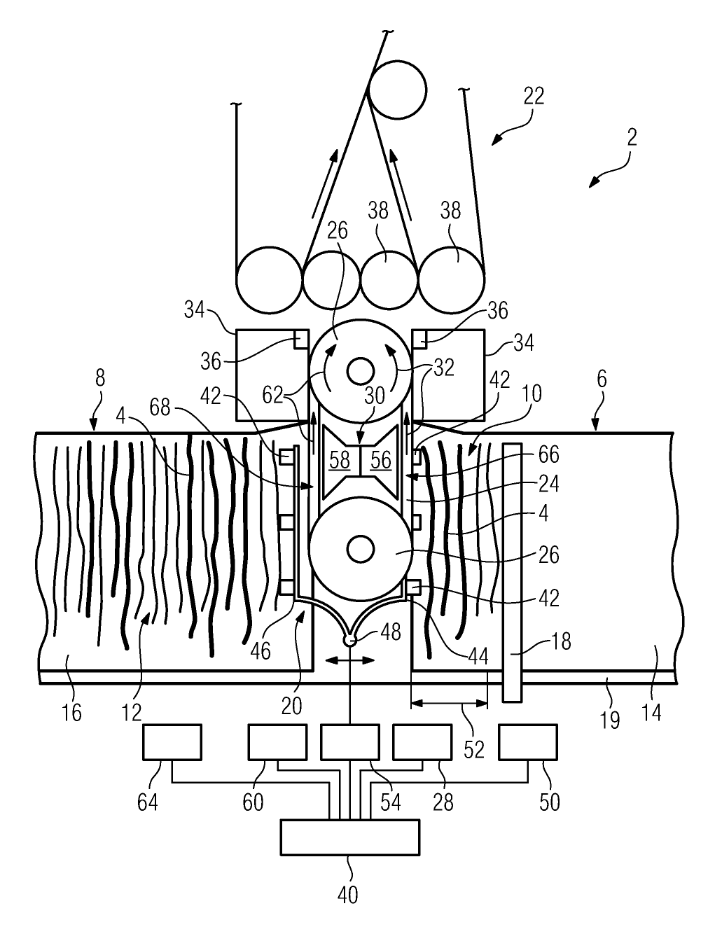

The invention will be described in detail with reference to an exemplary embodiment which is illustrated in the drawing by a single FIGURE. In the drawing, FIG. 1 shows a schematic representation of a device 2 for separating flat mail items 4 of differing size, shape and flexibility. The mail items 4 are deployed on edge with their long side downward on a transport means 6, 8 and there form two separating stacks, or stacks of mail items, 10, 12. The two transport means 6, 8 are implemented as flatbed conveyors and each comprise a conveyor belt 14, 16 for carrying and moving the mail items 4 and one or more paddles 18 which run in a guide 19 and can be moved mechanically in synchronism with the respective conveyor belt 14, 16. The respective paddles 18 keep the mail items 4 standing upright on the conveyor belts 14, 16 and confine the respective stacks of mail items 10, 12.

The mail items 4 are transported by means of appropriate movement of the conveyor belts 14, 16 and paddles 18 to an extraction means 20 which extracts a leading mail item 4 from one of the stacks of mail items 10, 12 and feeds it to a transport run 22 which is designed as a cover belt conveyor and which guides the mail item 4 to further handling devices such as a pattern recognition facility, a stamp canceling unit or a label sticker. In order to extract the mail items 4 from the stacks of mail items 10, 12 the extraction means 20 comprises an extraction element 24 in the form of a circulating extraction belt which is held by two rollers 26 and is driven in a circulatory motion by a servo motor 28 connected with the rollers 26. The extraction belt comprises five bands running parallel vertically above one another, forming a gap between each pair of bands, such that four horizontal gaps are present in the extraction belt. A suction means 30 sucks in air from these gaps, such that a slight underpressure prevails in the area of the gaps compared with the ambient environment of the extraction belt.

In order to extract the mail items 4 from a stack of mail items 10, 12 the respective stack of mail items 10, 12 is pressed by a slight pressure exerted by the conveyor belt 14, 16 and the paddle 18 against the extraction element 24, or the extraction belt, and the leading mail item 4 is additionally sucked towards the extraction belt by the underpressure, such that this mail item 4 lies snugly against the extraction belt. The extraction belt is now driven by the servo motor 28 in one direction of motion 32 and the mail item 4 adhering to the extraction belt is moved in the direction of the transport run 22. A wiper 34 prevents two or more mail items 4 which are caught up together from being transported simultaneously and a photosensor 36 registers the passage of the leading edge and trailing edge of the mail item. The moved mail item 4 is captured by rollers 38 of the transport run 22 and transported onwards.

After the leading mail item 4 has been extracted from a stack of mail items 10, 12, from the stack of mail items 10 in FIG. 1, a following mail item 4 is presented at the extraction belt and can be extracted from the stack of mail items 10. To this end, a point in time at which the leading edge of the following mail item 4 should pass the photosensor 36 is determined by a control unit 40. The point in time is determined from the speed of transportation of the mail items 4 in the transport run 22, the point in time at which the trailing edge of the preceding mail item 4 has passed the photosensor 36 and a predefined spacing between mail items 4 in the transport run 22. Accordingly, an extraction timing and/or an extraction speed is/are chosen by the control unit 40 and the following mail item 4 is extracted correspondingly from the stack of mail items 10. The spacing between the mail items 4 in the transport run 22 can be predefined by a person operating the device 2.

As a result of extracting mail items 4 from the stack of mail items 10 the latter is reduced, such that the pressure exerted by the mail items 4 against the extraction belt decreases. This pressure is measured by sensors 42. Three sensors 42 are assigned in each case to a stack of mail items 10, 12 and are secured to a retaining element 44, 46 of a retaining means 48. The two retaining elements 44, 46 are constructed symmetrically with respect to one another, secured to one another and can simultaneously be moved synchronously. They each have four fingers which engage in the four gaps between the bands of the extraction belt. In FIG. 1, the fingers of the retaining element 44 engage between the bands, whereby the fingers of the retaining element 46 are moved away from the extraction belt in the direction of the stack of mail items 12 and hold the mail items 4 of the stack of mail items 12 away from the extraction belt.

As soon as the pressure of the mail items 4 on the sensors 42 of the retaining element 44 drops below a value predefined by the control unit 40, a signal is issued by the control unit 40 to a drive 50 of the conveyor belt 14, which causes a movement of the conveyor belt 14 and of the paddle 18 for transporting the mail items 4 of the stack of mail items 10 in the direction of the extraction means 20. The pressure is increased as a result and after a certain conveying period—after a limit pressure is exceeded at the sensors 42—movement of the conveyor belt 14 and of the paddle 18 can stop again.

As a result of reducing the stack of mail items 10, the latter becomes ever smaller and the paddle 18 advances ever closer to the extraction means 20. Unless the stack of mail items 10 is replenished by an operator with a new stack of mail items 4 and the paddle 18 is withdrawn to the back again, then the paddle 18 eventually reaches a minimum distance 52 from a predefined reference point. This causes the control unit 40 to issue signals which result in units of the device 2 being switched over and in extraction of mail items 4 from the stack of mail items 10 being terminated.

In the first instance the drive 50 is stopped and a drive 54 of the retaining means 48 is activated, which switches over the retaining means 48. To this end, the retaining elements 44, 46 are moved synchronously from their position shown in FIG. 1 into a position symmetrical with this. This movement is a retaining movement of the retaining element 44 which now holds back mail items 4 from the stack of mail items 10 from the extraction belt, and it is simultaneously a release movement of the retaining element 46 which now allows mail items 4 from the stack of mail items 12 to reach the extraction belt. In addition, the suction means 30 is switched over by a drive 60 and as a result a suction direction is changed in that air is now no longer sucked in through a first intake port 56 but through an intake port 58 arranged opposite.

The extraction belt is then moved in a direction of motion 62 opposite to the direction of motion 32, such that the leading mail item 4 of the stack of mail items 12 lying against the extraction belt is accelerated in the direction of the transport run 22. The point in time the acceleration occurs is set by the control unit 40 such that a spacing from a leading edge of the accelerated mail item 4 to the trailing edge of the preceding mail item 4 from the stack of mail items 10 is the predetermined spacing between mail items 4 in the flow of mail items of the transport run 22.

Mail items 4 from the stack of mail items 12 are now separated, as described above with reference to the stack of mail items 10, whereby the transport means 8 is moved by means of a drive 64 controlled by the control unit 40. If the resting stack of mail items 10 is augmented again by an operator adding mail items 4 and the paddle 18 is drawn back, then the separation process is switched over again by means of a release signal from the operator and/or the control unit 40, with the result that mail items 4 from the stack of mail items 10 are again separated.

In this manner, two extraction areas 66, 68 of the extraction belt with opposite directions of motion 32, 62 are used for extracting mail items 4 from two stacks of mail items 10, 12 fed from opposite directions to the extraction means 20. It is thus possible by using a single and simple extraction means 20 and a single extraction belt to separate mail items 4 from two stacks of mail items 10, 12 moved in different directions.

1-8. (canceled)

9. An apparatus for separating flat mail items, comprising:
two transportation devices for transporting a first stack of mail items and a second stack of mail items movable independently of one another;
a singulating device for pulling mail items from the first stack and the second stack of mail items and feeding the mail items into a transportation path, said singulating device having a integrally formed pulling element for pulling mail items from the first stack and the second stack of mail items;
a retaining device for selectively feeding mail items from either the first or the second stack of mail items to said pulling element, said retaining device having first and second retaining elements for retaining mail items from the first stack of mail items or the second stack of mail items, respectively; and
a drive configured to move said first and second retaining elements in a synchronized manner such that a retaining movement of said first retaining element is coupled with a release movement of said second retaining element.

10. The apparatus according to claim 9, wherein the two transportation devices are adapted for transporting the first stack and the second stack of mail items from mutually different directions to said pulling element.

11. The apparatus according to claim 9, wherein said pulling element is mounted such that it can be moved in two directions being inverse to each other.

12. The apparatus according to claim 9, wherein said pulling element has a first extraction area with a first direction of motion and a second extraction area with a second direction of motion opposite the first direction, and wherein the transportation devices are adapted for transporting the first stack of mail items to the first pulling area and the transporting the second stack of mail items to the second pulling area.

13. The apparatus according to claim 9, which comprises a sucking device for sucking the mail items from the first and second stacks of mail items the sucking device being disposed inside an area circumscribed by said pulling element.

14. The apparatus according to claim 13, wherein a suction direction of said sucking device can be switched over.

15. The apparatus according to claim 9, which further comprises a control unit for controlling a movement of said pulling element in such a manner that between two consecutive mail items from different stacks the same distance is set than between two consecutive mail items from the same stack.

16. The apparatus according to claim 9, wherein said retaining elements carry sensors for outputting signals which are usable for controlling a movement of the first and second stacks of mail items.
